(19) United States
(12) Patent Application Publication
(10) Pub. No.: US 2013/0222462 A1
(43) Pub. Date: Aug. 29, 2013

(54) INK JET IMAGE FORMING METHOD

(71) Applicant: CANON KABUSHIKI KAISHA, (US)

(72) Inventors: Taketoshi Okubo, Asaka-shi (JP); Ikuo Nakazawa, Kawasaki-shi (JP); Shoji Koike, Yokohama-shi (JP)

(73) Assignee: CANON KABUSHIKI KAISHA, Tokyo (JP)

(21) Appl. No.: 13/762,997

(22) Filed: Feb. 8, 2013

(30) Foreign Application Priority Data
Feb. 29, 2012 (JP) 2012-042805

(51) Int. Cl. B41J 2/01

(52) U.S. Cl. CPC B41J 2/01
USPC 347/20

(57) ABSTRACT

An ink jet image forming method for forming an image including applying ink to a printing paper sheet using a recording head of an ink jet system. The ink contains a self-dispersion pigment, a polymer particle having a glass transition temperature of 25° C. or lower, and water and has a surface tension of 34 mN/m or less. When recording a line image having a recording density of 600 dpi or more and 4,800 dpi or less and a width of adjacent four pixels or more by conducting one scanning of the recording head, an amount of an ink droplet applied from the recording head is 0.6 pL or more and 6.0 pL or less, and an average ink application amount per unit area in the line image is 0.3 μL/cm² or more and 1.5 μL/cm² or less.

### BACKGROUND OF THE INVENTION

1. Field of the Invention

The present invention relates to an ink jet image forming method.

2. Description of the Related Art

In recent years, studies have been made on use of a low-cost general-purpose printing paper sheet having a coating layer formed thereon as a recording medium used for an ink jet image forming method. However, a printing paper sheet having a coating layer formed thereon has a low ability of absorbing ink. Therefore, when a line image is formed (recorded) on a printing paper sheet having a coating layer formed thereon using an ordinary ink jet printer, problems arise such as liability to line thickening or unevenness in the line image, delay in fixing of the line image, and liability to lowering of the scratch resistance of the line image. In particular, when small size letter are printed, such a problem that the line blurs to make the letters unclear is liable to arise. Further, when a line image is formed, in a system that conducts recording by only one passage of an ink jet head, in comparison with a multi-pass method of dividedly applying ink, such a problem that ink droplets interfere with each other, known as “beading”, is conspicuously liable to occur.

In order to solve various problems which arise when an image is formed on a printing paper sheet having a coating layer formed thereon, Japanese Patent Application Laid-Open No. 2009-226715 proposes a technology of recording an image with an ink which dries fast using an ink jet recording apparatus including an ink drying unit.

However, it is difficult even for the ink used in the technology proposed in Japanese Patent Application Laid-Open No. 2009-226715 to suppress line thickening and image unevenness of a formed line image when the ink is used in the system that conducts recording with only one passage of an ink jet head. Further, it is also difficult to form a line image excellent in fixability.

### SUMMARY OF THE INVENTION

The present invention has been made in view of the problems of the conventional technology. Accordingly, it is an object of the present invention to provide an ink jet image forming method which suppresses line thickening and image unevenness even without an ink drying unit, and can form a line image excellent in fixability on a printing paper sheet having a coating layer formed thereon by one passage.

The above-mentioned problems are solved by an exemplary embodiment of the present invention described below. That is, according to the exemplary embodiment of the present invention, there is provided an ink jet image forming method for forming an image including applying ink to a printing paper sheet using a recording head of an ink jet system, where the ink contains a self-dispersion pigment, a polymer particle having a glass transition temperature of 25° C. or lower, and water and has a surface tension of 34 mN/m or less, and wherein when recording a line image having a recording density of 600 dpi or more and 4,800 dpi or less and a width of adjacent four pixels or more by conducting one scanning of the recording head, an amount of an ink droplet applied from the recording head is 0.6 pL or more and 6.0 pL or less, and an average ink application amount per unit area in the line image is 0.3 μL/cm² or more and 1.5 μL/cm² or less.

According to the ink jet image forming method of the present invention, even without the ink drying unit, line thickening and image unevenness can be suppressed and the line image excellent in fixability can be formed on the printing paper sheet having the coating layer formed thereon by one passage.

Further features of the present invention will become apparent from the following description of exemplary embodiments with reference to the attached drawings.

### BRIEF DESCRIPTION OF THE DRAWINGS

FIG. 1 is a schematic view illustrating an exemplary ink jet recording apparatus having a serial type recording head.

FIG. 2 is a schematic view illustrating an exemplary serial type recording head.

FIG. 3 is a schematic view illustrating an exemplary line type recording head.

### DESCRIPTION OF THE EMBODIMENTS

The present invention is described in detail in the following with reference to exemplary embodiments. The inventors of the present invention studied ink jet image forming methods which can fix at high speed a line image having sufficient scratch resistance on a printing paper sheet having a coating layer formed thereon without causing line thickening and image unevenness. As a result, the inventors of the present invention have found that, when ink containing a self-dispersion pigment and polymer particles having a glass transition temperature of 25° C. or lower is applied under certain conditions to form a line image, even without adopting an ink drying unit such as a forced drying apparatus, line thickening and image unevenness are not caused. The mechanism by which such effects are obtained is not clarified, but the inventors of the present invention have the following assumption.

When an ink droplet is ejected from a recording head and applied to a printing paper sheet having a coating layer formed thereon, first, absorption of a liquid component of the ink in the printing paper sheet begins. A printing paper sheet having a coating layer formed thereon usually does not include an ink receiving layer. Therefore, the penetration rate of the liquid component is extremely slow compared with the cases of an ink-jet-exclusive paper sheet and a plain paper sheet. It follows that, when a line image is recorded on a printing paper sheet having a coating layer formed thereon using an ordinary ink jet printer designed for an ink-jet-exclusive paper sheet or plain paper sheet, adjacent ink droplets interfere with each other before the liquid component penetrates the paper sheet to cause beading. Further, line thickening, and image unevenness due to the coffee stain phenomenon are caused.

On the other hand, ink used in an ink jet image forming method according to the present invention contains polymer particles having a glass transition temperature of 25° C. or lower. When this ink is used to perform ink jet recording on a printing paper sheet having a coating layer formed thereon, after an ink droplet is applied to the printing paper sheet, a small amount of liquid is rapidly absorbed in the printing paper sheet. Further, the polymer particles are molten to form a film. This is thought to abruptly increase the viscosity of the ink droplet to suppress line thickening. Further, a pigment is less liable to move in an ink droplet. This is thought to suppress image unevenness.

Further, the ink to be used in the ink jet image forming method according to the present invention has a surface tension of 34 mN/m or less, and thus, wetting by the ink droplet of the printing paper sheet and absorption of the ink droplet in the printing paper sheet rapidly progress. This is thought to promote suppression of line thickening due to increase in viscosity of the ink droplet and suppression of image unevenness due to limited movement of the pigment. Further, in the ink jet image forming method according to the present invention, the amount of an ink droplet applied onto the printing paper sheet is 0.6 pL or more and 6.0 pL or less. Further, the average ink application amount per unit area in a line image is 0.3 μL/cm² or more and 1.5 μL/cm² or less. Application of the ink under these conditions, together with the characteristics of the ink described above, is thought to exert synergetic effects of the present invention.

<Image Forming Method>

A “line image” according to the present invention means an image formed of a line having a certain length and a certain width. A line image may be a straight line or a curved line, and may have a single color or multiple colors. Further, a line portion of a formed image and a line forming a letter are also included in the concept of the “line image” according to the present invention. According to the present invention, there is provided an ink jet image forming method for forming a line image having a recording density of 600 dpi or more and 4,800 dpi or less and a width of adjacent four pixels or more. In a line image having a width of less than four pixels, dots are less liable to interfere with each other, and line thickening is less liable to cause a problem. Therefore, according to the present invention, a line image having a width of four pixels or more is formed. The upper limit of the width of a line image is not specifically limited, but the ink jet image forming method according to the present invention is more effective in forming a line image having a width of 6 mm (142 pixels in the case of 600 dpi and 1,134 pixels in the case of 4,800 dpi) or less. Further, the ink jet image forming method according to the present invention is particularly effective in forming a line image having a width of 3 mm (71 pixels in the case of 600 dpi and 567 pixels in the case of 4,800 dpi) or less.

In the ink jet image forming method according to the present invention, the amount of an ink droplet applied onto a printing paper sheet is 0.6 pL or more and 6.0 pL or less. By setting the amount of an ink droplet to be in the above-mentioned range, line thickening and image unevenness of a formed line image can be suppressed. When the amount of an ink droplet applied onto a printing paper sheet is less than 0.6 pL, the location at which the ink droplet applied is liable to deviate due to the influence of an airflow, and there are cases in which the edges of a drawn line image are not sharp. Therefore, the amount of an ink droplet applied onto a printing paper sheet is preferably 0.8 pL or more, more preferably 1.0 pL or more. On the other hand, when the amount of an ink droplet applied onto a printing paper sheet is more than 6.0 pL, the time necessary for viscosity increase of the ink becomes longer. Therefore, line thickening cannot be suppressed, and the fixability of the line image is reduced. Therefore, the amount of an ink droplet applied onto a printing paper sheet is preferably 5.0 pL or less, more preferably 4.5 pL or less, particularly preferably 3.5 pL or less.

In the ink jet image forming method according to the present invention, the average ink application amount per unit area in a line image drawn with a recording density of 600 to 4,800 dpi is 0.3 μL/cm² or more and 1.5 μL/cm² or less. If the average ink application amount is less than 0.3 μL/cm², adjacent ink droplets almost do not interfere with each other, and thus, line thickening, which is one of the problems to be solved by the present invention, does not occur. Therefore, it is more effective to set the average ink application amount to be 0.4 μL/cm² or more, and it is further effective to set the average ink application amount to be 0.5 μL/cm² or more. On the other hand, if the average ink application amount is more than 1.5 μL/cm², adjacent ink droplets interfere with each other, and a large ink droplet is formed on the printing paper sheet. Therefore, the time necessary for viscosity increase of the ink becomes longer, and thus, line thickening cannot be suppressed, and the fixability of the line image is reduced. In order to more effectively suppress line thickening of a line image, the average ink application amount per unit area in the line image is preferably 1.3 μL/cm² or less, more preferably 1.0 μL/cm² or less.

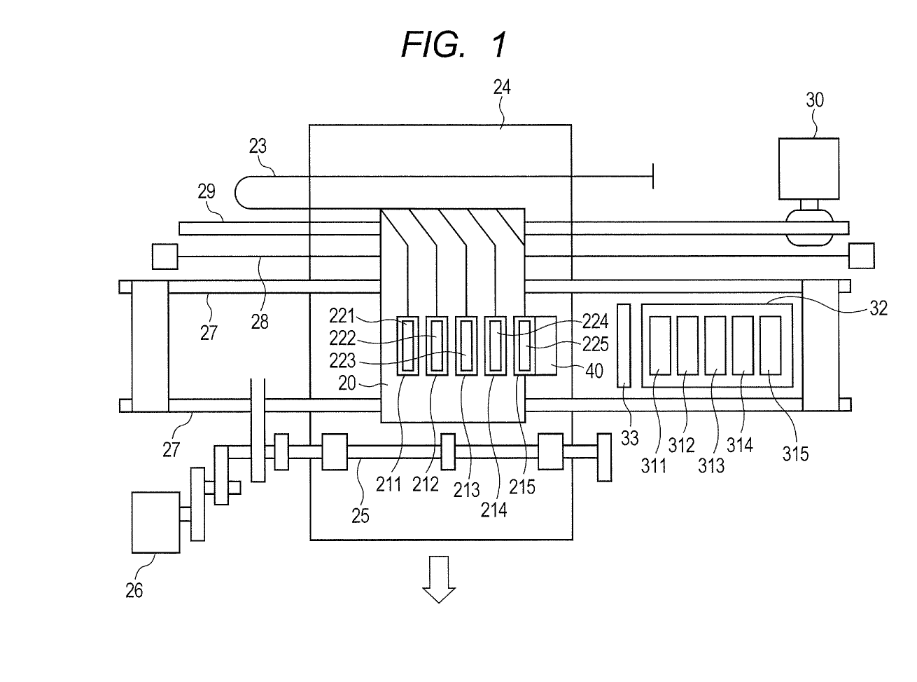

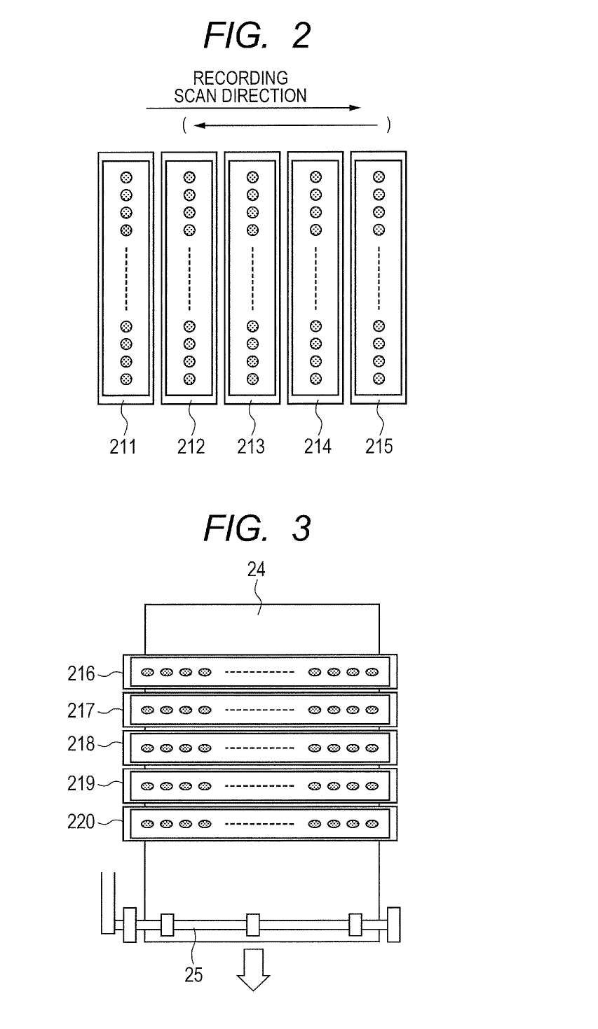

“One passage” according to the present invention means that the number of times the ink jet head scans is one with regard to all parts of the line image to be formed. Specific examples of a preferred recording apparatus for carrying out the ink jet image forming method according to the present invention include a serial type printer (see FIGS. 1 and 2) and a line type printer (see FIG. 3). For example, when the serial type printer is used, a line image is formed while a recording head which ejects ink moves in a main scan direction (direction of the arrow in FIG. 2). When the recording head reaches an end of the printing paper sheet, the printing paper sheet is fed in a sub scan direction by the width of the recorded line image. After that, a line image is formed while the recording head moves in the main scan direction again (see FIG. 2). In this way, the number of times the recording head passes is one with regard to all parts of the line image to be recorded. Note that, from the viewpoint of suppressing a blank portion on the formed line image, when the recording head moves in the main scan direction and when the recording head moves in the sub scan direction, regions (areas) which the recording head scans may overlap by 10% or less. Further, when the line type printer is used, ink is applied while the printing paper sheet is fed in the main scan direction. Therefore, the number of times the recording head passes is one with regard to all parts of the line image to be recorded.

Further, according to the present invention, ink may be dividedly applied insofar as a line image is formed by one passage. Specifically, ink of the same color or different colors may be dividedly applied from at least two nozzle arrays included in the recording head. Even when ink is dividedly applied in this way, interference between ink droplets can be suppressed to suppress image unevenness of the formed line image. When ink is dividedly applied in multiple times, it is preferred that the time difference between the first application and the last application be 200 msec or less. This allows the effect of the present invention to be exerted more remarkably. Note that, if the time difference between the first application and the last application is more than 200 msec, there are cases in which line thickening of the formed line image can be suppressed even when the constitution of the ink jet image forming method according to the present invention is not adopted.

<Ink>

Coloring Material

A coloring material to be incorporated into the ink to be used in the ink jet image forming method according to the present invention is a self-dispersion pigment. The self-dispersion pigment is preferably an anionic self-dispersion pigment. In the case of the anionic self-dispersion pigment, an anionic functional group directly bonded to the pigment is likely to have an interaction with the coating layer of a printing paper sheet, as compared to an anionic polymer-dispersed pigment. Accordingly, unevenness hardly occurs in a line image to be formed. The anionic self-dispersion pigment is suitable also because it obviates the need for the incorporation of a water-soluble polymer and hence its solid-liquid separation with respect to water easily progresses, allowing a line image excellent in scratch resistance to be formed. Note that, the anionic functional group means such a functional group that a half or more of hydrogen ions can be dissociated at a pH of 7.0. Specific examples of the anionic functional group may include a carboxyl group, a sulfo group, and a phosphonic acid group. Of those, a carboxyl group or a phosphonic acid group is preferred as the anionic functional group from the viewpoint of the suppression of image unevenness. Note that, when the self-dispersion pigment is used in combination with a water-soluble compound to be described later, a synergetic effect is exerted, with the result that solid-liquid separation of the ink on a paper sheet progresses more rapidly to further improve the fixability of a line image.

An ink set for forming line images with inks of a plurality of colors basically includes black, cyan, magenta, and yellow inks. Note that, red, blue, green, gray, pale cyan, and pale magenta inks, for example, may be added to the ink set. The pigments contained in the inks to be added are also preferably self-dispersion pigments.

The self-dispersion pigment is generally a pigment that has been dispersed and stabilized without requiring a dispersant by introducing a water-soluble functional group such as an anionic functional group to the surface of the pigment directly or via another atomic group. As the pigment before the dispersion stabilization, there may be used various hitherto known pigments such as those listed in International Patent WO2009/014242A.

As a method for the introduction of an anionic functional group to the surface of the pigment, there may be given, for example, a method involving performing oxidation treatment on carbon black. Examples of the method involving performing oxidation treatment may include methods involving performing treatment with hypochlorite, ozone water, hydrogen peroxide, chlorite, nitric acid, or the like. Of those, self-dispersion carbon black to be obtained by performing oxidation treatment on the surface of carbon black with sodium hypochlorite is preferred from the viewpoint of the suppression of image unevenness. Further, other examples of the method involving performing oxidation treatment may include surface treatment methods involving using a diazonium salt as described in Japanese Patent No. 3808504, Japanese Patent Application Laid-Open No. 2009-515007, and Japanese Patent Application Laid-Open No. 2009-506196. A commercially available pigment having a water-soluble (hydrophilic) functional group such as an anionic functional group introduced into its surface may be specifically exemplified by the following trade names: CW-1, CW-2, and CW-3 (all of which are manufactured by ORIENT CHEMICAL INDUSTRIES CO., LTD.); and CAB-O-JET 200, CAB-O-JET 300, and CAB-O-JET 400 (manufactured by Cabot Corporation). Note that, the CW-2 and the CAB-O-JET 300 are self-dispersion carbon blacks including ionized carboxyl groups in a certain proportion or more as the anionic functional groups and including sodium ions as counter ions. That is, those carbon blacks are carbon blacks having —COONa. Other specific examples of the functional group to be introduced through surface treatment may include —SO₃H, —SO₂H, and —P(═O)(OH)₂. Those functional groups are ionized in an aqueous medium in a certain proportion or more. Accordingly, pigment particles are stably dispersed owing to repulsion of charges. Examples of the counter ions may include: alkali metal ions such as a lithium ion, a sodium ion, a potassium ion, a rubidium ion, and a cesium ion; an ammonium ion; and ions derived from amines such as methylamine, ethylamine, dimethylamine, 2-hydroxyethylamine, di(2-hydroxyethyl)amine, and tri(2-hydroxyethyl)amine. The counter ions are preferably a lithium ion, a sodium ion, a potassium ion, a rubidium ion, a cesium ion, and an ammonium ion, more preferably a potassium ion, a rubidium ion, a cesium ion, and an ammonium ion. As a method for the exchange of counter ions of the self-dispersion pigment into desired counter ions, there is, for example, a method involving adding, to the self-dispersion pigment, a salt which can provide counter ions in an amount more than the amount of anionic functional groups in the self-dispersion pigment. Further, there is, for example, a method, as described in Japanese Patent No. 4001922 and Japanese Patent Application Laid-Open No. H11-222573, of repeatedly conducting the steps of exchanging counter ions by performing the addition of an aqueous solution containing target counter ions of interest and desalting (ion exchange method).

The average particle diameter of the self-dispersion pigment is preferably 40 nm or more, more preferably 60 nm or more, particularly preferably 70 nm or more. Further, the average particle diameter of the self-dispersion pigment is preferably 140 nm or less, more preferably 130 nm or less, particularly preferably 120 nm or less. The average particle diameter of the self-dispersion pigment may be measured by a measuring method involving utilizing the scattering of laser light. Specifically, the measurement may be performed with “FPAR-1000” (trade name, manufactured by Otsuka Electronics Co., Ltd., cumulant method analysis), trade name “Nanotrac UPA150EX” (manufactured by NIKKISO CO., LTD., a 50% cumulative value is used), or the like. Note that, the average particle diameter of the self-dispersion pigment in the present invention is a physical property value defined by a light scattering average particle diameter, and is determined by a dynamic light scattering method in a liquid.

As required, two or more kinds of pigments may be incorporated in combination into one ink. The addition amount of the self-dispersion pigment in the ink is set to preferably 0.5 mass % or more, more preferably 1 mass % or more, particularly preferably 1.5 mass % or more with respect to the total amount of the ink in order to provide sufficient color developability. Further, the use of an ink containing an excess amount of the pigment may reduce the gloss of a line image. In order to improve the gloss of a line image, the height of a dot is preferably reduced. To that end, the concentration of the pigment is set to preferably 8 mass % or less, more preferably 6 mass % or less, particularly preferably 5 mass % or less.

Aqueous Medium

The ink to be used in the ink jet image forming method according to the present invention contains water as an essential component. The content of water in the ink is preferably 30 mass % or more, more preferably 95 mass % or less with respect to the total mass of the ink. Further, water and a water-soluble compound are preferably used in combination as an aqueous medium. Herein, the water-soluble compound means a compound having such a high hydrophilicity that, in a mixed liquid of the compound with water at a concentration of 20 mass %, the compound is mixed in water without causing phase separation. Note that, a compound that easily vaporizes to an excessive degree is not preferred as the water-soluble compound from the viewpoint of the prevention of the clogging of the ejection orifice of the recording head. Therefore, the vapor pressure at 20° C. of the water-soluble compound is preferably 0.04 mmHg or less.

The ink preferably contains a water-soluble compound having a hydrophilicity-hydrophobicity coefficient defined by the following equation (A) of 0.26 or more. Further, depending on the kind of paper sheet, it is preferred to use an ink in which a water-soluble compound having a hydrophilicity-hydrophobicity coefficient defined by the following equation (A) of 0.26 or more and less than 0.37 and a water-soluble compound having a hydrophilicity-hydrophobicity coefficient of 0.37 or more are used in combination. When an ink composition using the hydrophobic water-soluble compound having a hydrophilicity-hydrophobicity coefficient of 0.37 or more in combination is adopted, image unevenness is further suppressed and the scratch resistance of an image is further improved because of the acceleration of the vaporization of water.

(Hydrophilicity-hydrophobicity coefficient)=((Water activity of 20-mass % aqueous solution)−(Molar fraction of 20-mass % aqueous solution))/(1−(Molar fraction of water in 20-mass % aqueous solution)) Equation (A)

The water activity value in the equation (A) is represented by the following equation: water activity value=(water vapor pressure of aqueous solution)/(water vapor pressure of pure water). The water activity value may be measured by various methods, and any one of the measuring methods may be employed. Of those, a chilled mirror dew point measuring method is suitable. The term “water activity value” as used herein refers to a value measured for a 20-mass % aqueous solution (25° C.) of the water-soluble compound by the chilled mirror dew point measuring method with “Aqualab CX-3TE” (trade name, manufactured by DECAGON).

According to Raoult's law, the rate of vapor pressure reduction of a dilute solution equals the molar fraction of the solute irrespective of the kinds of the solvent and the solute, and hence the molar fraction of water in an aqueous solution equals the water activity value. However, when the water activities of aqueous solutions of various water-soluble compounds are measured, many of the water activities do not equal the molar fraction of water.

A water activity value of an aqueous solution lower than the molar fraction of water means that the water vapor pressure of the aqueous solution is smaller than the theoretically calculated value and the vaporization of water is suppressed by the presence of the solute. This indicates that the solute is a substance having a large hydration force. On the other hand, a water activity value of an aqueous solution higher than the molar fraction of water suggests that the solute is a substance having a small hydration force.

The inventors of the present invention have focused their attention on the fact that the degree of hydrophilicity or hydrophobicity of a water-soluble compound to be incorporated into an ink significantly affects the acceleration of solid-liquid separation between the self-dispersion pigment and the aqueous medium as well as various ink performances. Based on such focus of attention, the inventors of the present invention have defined the hydrophilicity-hydrophobicity coefficient represented by the equation (A). The water activity value is measured for aqueous solutions of various water-soluble compounds at the same concentration of 20 mass %. Then, the measured values are converted by the equation (A). Thus, a relative comparison of the degrees of hydrophilicity or hydrophobicity of water-soluble compounds can be performed even when the compounds have different molar fractions of water owing to differences in molecular weight of the solutes. Note that, the water activity value of an aqueous solution does not exceed 1, and hence the maximum value of the hydrophilicity-hydrophobicity coefficient is 1. Table shows the hydrophilicity-hydrophobicity coefficients of various water-soluble compounds calculated by the equation (A). Note that, the water-soluble compound is not limited to those shown in Table 1.

TABLE 1

| | Hydrophilicity- |
|---|---|
| | Hydrophobicity |
| Substance Name | Coefficient |
| 1,2-Hexanediol | 0.97 |
| 1,2-Pentanediol | 0.93 |
| 3-Methyl-1,3-butanediol | 0.90 |
| 1,2-Butanediol | 0.90 |
| 2,4-Pentanediol | 0.88 |
| 1,6-Hexanediol | 0.76 |
| 1,7-Heptanediol | 0.73 |
| 3-Methyl-1,5-pentanediol | 0.54 |
| 1,5-Pentanediol | 0.41 |
| Trimethylolpropane | 0.31 |
| Ethylene urea | 0.30 |
| 1,2,6-Hexanetriol | 0.28 |
| 1,2,3-Butanetriol | 0.22 |
| Sorbitol | 0.21 |
| Urea | 0.20 |
| Diethylene glycol | 0.15 |
| 1,2,4-Butanetriol | 0.15 |
| Glycerol | 0.11 |
| Diglycerol | 0.08 |
| Triethylene glycol | 0.07 |
| Polyethylene glycol 200 | −0.09 |
| Polyethylene glycol 600 | −0.43 |

A water-soluble compound having a desired hydrophilicity-hydrophobicity coefficient is preferably selected from various compounds appropriate for the ink for ink jet recording and used. A water-soluble compound having a hydrophilicity-hydrophobicity coefficient of 0.26 or more to have a low hydrophilic tendency is preferred from the viewpoints of further suppressing line thickening and image unevenness and further improving fixability. Of such compounds, a compound which has a glycol structure and in which the number of carbon atoms to which hydrophilic groups are bonded is equal to or smaller than the number of carbon atoms to which hydrophilic groups are not bonded is preferred as the water-soluble compound. Such water-soluble compound is considered to have a relatively low affinity for water and for a self-dispersion pigment but have a high affinity for a coating layer of a printing paper sheet. Accordingly, after the application of an ink droplet to a printing paper sheet, such water-soluble compound tends to be rapidly absorbed by the coating layer, resulting in rapid fixation of a line image.

Trimethylolpropane is particularly preferred as the water-soluble compound having a hydrophilicity-hydrophobicity coefficient defined by the equation (A) of 0.26 or more and less than 0.37. Further, a compound having a glycol structure with 4 to 7 carbon atoms is preferred as the water-soluble compound having hydrophilicity-hydrophobicity coefficient of 0.37 or more. Of such compounds, 1,2-hexanediol, 1,2-pentanediol, and 1,6-hexanediol are preferred. 1,2-hexanediol is particularly preferred because it has a water activity value of 0.37 or more and a vapor pressure at 20° C. of 5.3 Pa or less. The content of the water-soluble compound in the ink is preferably 5.0 mass % or more, more preferably 6.0 mass % or more, particularly preferably 7.0 mass % or more with respect to the total mass of the ink. Further, the content of the water-soluble compound in the ink is preferably 40.0 mass % or less, more preferably 35.0 mass % or less, particularly preferably 30.0 mass % or less with respect to the total mass of the ink.

Polymer Particle

Polymer particles are incorporated into the ink to be used in the ink jet image forming method according to the present invention. The glass transition temperature of the polymer particles is 25° C. or lower. By using the ink containing such polymer particles, line thickening and image unevenness are suppressed, and a line image excellent in fixability and scratch resistance can be formed. The glass transition temperature (Tg) of the polymer particles is limited to 25° C. or lower because the average temperature of an in-room environment is assumed to be approximately 25° C. When polymer particles having a glass transition temperature higher than 25° C. are used, the polymer particles are less liable to form a film even after an ejected ink droplet is applied to a printing paper sheet. This means that the viscosity of the ink droplet is not abruptly increased. Therefore, line thickening cannot be suppressed, and the fixability of the line image is reduced. It is preferred that the glass transition temperature of the polymer particles be 15° C. or lower. Further, the glass transition temperature of the polymer particles is preferably −60° C. or higher, more preferably −50° C. or higher. If the glass transition temperature of the polymer particles is lower than −60° C., there are cases in which the strength of the formed film is too low. Note that, the glass transition temperature of the polymer particles can be measured according to an ordinary method. Specifically, the measurement can be made using a thermal analyzer such as a differential scanning calorimeter (DSC).

The polymer particles preferably have satisfactory dispersibility in an aqueous medium. A polymer constituting the polymer particles is preferably a hydrophilic acrylic polymer or a hydrophilic urethane-based polymer. The hydrophilic acrylic polymer is a copolymer obtained by copolymerization of an acrylic monomer and any other monomer copolymerizable with the acrylic monomer. Examples of the acrylic monomer may include an unsaturated carboxylic acid monomer, an unsaturated sulfonic acid monomer, an acrylic acid ester monomer, a methacrylic acid ester monomer, and a crosslinkable acrylic monomer having two or more polymerizable double bonds.

Specific examples of the unsaturated carboxylic acid monomer may include acrylic acid, methacrylic acid, itaconic acid, fumaric acid, and maleic acid. Specific examples of the unsaturated sulfonic acid monomer may include 3-sulfopropyl (meth)acrylate. Specific examples of the acrylic acid ester monomer may include acrylic acid esters such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate, glycidyl acrylate, phenoxyethyl acrylate, and 2-hydroxyethyl acrylate.

Specific examples of the methacrylic acid ester monomer may include methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, glycidyl methacrylate, phenoxyethyl methacrylate, 2-hydroxyethyl methacrylate, polyethylene glycol monomethacrylate, and polypropylene glycol methacrylate.

Specific examples of the crosslinkable acrylic monomer having two or more polymerizable double bonds may include: diacrylate compounds such as polyethylene glycol diacrylate, triethylene glycol diacrylate, 1,3-butylene glycol diacrylate, 1,4-butylene glycol diacrylate, 1,6-hexanediol diacrylate, neopentyl glycol diacrylate, 1,9-nonanediol diacrylate, polypropylene glycol diacrylate, 2,2′-bis(4-acryloxypropyloxyphenyl)propane, 2,2′-bis(4-acryloxydiethoxyphenyl)propane, and N,N′-methylenebisacrylamide; triacrylate compounds such as trimethylolpropane triacrylate, trimethylolethane triacrylate, and tetramethylolmethane triacrylate; tetraacrylate compounds such as ditrimethylol tetraacrylate, tetramethylolmethane tetraacrylate, and pentaerythritol tetraacrylate; hexaacrylate compounds such as dipentaerythritol hexaacrylate; dimethacrylate compounds such as ethylene glycol dimethacrylate, diethylene glycol dimethacrylate, triethylene glycol dimethacrylate, polyethylene glycol dimethacrylate, 1,3-butylene glycol dimethacrylate, 1,4-butylene glycol dimethacrylate, 1,6-hexanediol dimethacrylate, neopentyl glycol dimethacrylate, dipropylene glycol dimethacrylate, polypropylene glycol dimethacrylate, polybutylene glycol dimethacrylate, and 2,2′-bis(4-methacryloxydiethoxyphenyl)propane; trimethacrylate compounds such as trimethylolpropane trimethacrylate and trimethylolethane trimethacrylate; and methylenebisacrylamide.

Further, specific examples of the monomer copolymerizable with an acrylic monomer may include: aromatic vinyl monomers such as styrene, α-methylstyrene, vinyltoluene, 4-t-butylstyrene, chlorostyrene, vinylanisole, vinylnaphthalene, and divinylbenzene; olefins such as ethylene and propylene; dienes such as butadiene and chloroprene; vinyl monomers such as vinyl ether, vinyl ketone, and vinylpyrrolidone; acrylamides such as acrylamide, methacrylamide, and N,N′-dimethylacrylamide; hydroxy group-containing monomers such as 2-hydroxyethyl acrylate, 2-hydroxypropyl acrylate, 2-hydroxyethyl methacrylate, and 2-hydroxypropyl methacrylate; and unsaturated sulfonic acid monomers such as styrenesulfonic acid and 2-acrylamide-2-methylpropanesulfonic acid.

The weight-average molecular weight of the polymer is preferably 100,000 or more and 50,000,000 or less from the viewpoints of the ejection characteristic of the ink, print density, and scratch resistance. Further, the weight-average molecular weight of the polymer is more preferably 200,000 or more, particularly preferably 250,000 or more. Further, the weight-average molecular weight of the polymer is more preferably 10,000,000 or less, still more preferably 8,000,000 or less. When the weight-average molecular weight of the polymer is less than 100,000, the scratch resistance of a line image to be formed may be reduced. On the other hand, when the weight-average molecular weight of the polymer is more than 50,000,000, the ejection characteristic of the ink may be impaired.

The polymer particles are blended in the ink in, for example, a state of a polymer emulsion in which the polymer particles are dispersed in a solvent. The content of the polymer emulsion in the ink is preferably 0.1 mass % or more and 10.0 mass % or less, more preferably 0.5 mass % or more and 5.0 mass % or less in terms of solid content with respect to the total mass of the ink. When the content of the polymer emulsion is less than 0.1 mass % in terms of solid content, the fixability of a line image may be insufficient. On the other hand, when the content of the polymer emulsion is more than 10.0 mass % in terms of solid content, the dispersion stability of the self-dispersion pigment may be reduced.

The mass ratio (P/B ratio) of the solid content of the self-dispersion pigment (P) to that of the polymer particle (B) in the ink is preferably 2.0 or less, more preferably 1.0 or less, particularly preferably 0.5 or less. The control of the P/B ratio to the numerical range further improves the fixability of a line image.

Surfactant

A surfactant is preferably incorporated into the ink to be used in the ink jet image forming method according to the present invention. The incorporation of the surfactant can provide more balanced ejection stability of the ink. The surfactant is preferably a nonionic surfactant. Further, of the nonionic surfactants, ethylene oxide adducts of a polyoxyethylene alkyl ether, acetylene glycol, and the like are preferred. Those nonionic surfactants have HLB values (hydrophile-lipophile balances) of 10 or more. The content of the surfactant in the ink is set to preferably 0.1 mass % or more, more preferably 0.2 mass % or more, particularly preferably 0.3 mass % or more with respect to the total mass of the ink. Further, the content of the surfactant in the ink is set to preferably 5.0 mass % or less, more preferably 4.0 mass % or less, particularly preferably 3.0 mass % or less with respect to the total mass of the ink.

Other Additives

As required, various additives may be incorporated into the ink to be used in the ink jet image forming method according to the present invention for the purpose of, for example, adjusting physical property values of the ink. Specific examples of the additives may include a viscosity adjuster, an antifoaming agent, an antiseptic agent, an antifungal agent, an antioxidant, and a penetrant.

Surface Tension

The surface tension of the ink to be used in the ink jet image forming method according to the present invention is 34 mN/m or less, preferably 33 mN/m or less, more preferably 32 mN/m or less. Further, the surface tension of the ink is preferably 20 mN/m or more, more preferably 23 mN/m or more, particularly preferably 26 mN/m or more. By using an ink having a surface tension in the above-mentioned range, the effects of the present invention that line thickening and image unevenness are suppressed and a line image excellent in fixability can be formed are exerted at the maximum. If the surface tension of the ink is more than 34 mN/m, wetting by an ink droplet of the coating layer of the printing paper sheet is less liable to occur, and the absorption rate of the liquid component in the coating layer becomes lower to reduce the fixability of a line image. Note that, the surface tension of the ink is measured using the Wilhelmy plate method. Specific examples of measuring apparatus for measuring the surface tension of the ink include CBVP-Z (trade name, manufactured by Kyowa Interface Science Co., Ltd).

Viscosity

The viscosity of the ink to be used in the ink jet image forming method according to the present invention is preferably 14 mPa·s or less, more preferably 10 mPa·s or less, particularly preferably 6 mPa·s. By using ink having a viscosity in the above-mentioned range, an ink droplet can be ejected from a recording head of a recording apparatus such as an ink jet printer at a high frequency with ease, which facilitates application of the ink to the ink jet image forming method according to the present invention in which high speed printing is performed.

<Recording Apparatus>

The recording apparatus suitably used in the ink jet image forming method according to the present invention is one having a recording head mounted thereon for ejecting and applying ink onto a printing paper sheet. The method of ejecting ink of the recording head is not specifically limited insofar as the above-mentioned ink can be ejected therefrom. As the method of ejecting ink, a method in which pressure is applied to ink by deformation of a piezoelectric element provided in a pump or a flow path, a method in which thermal energy is given to ink to generate a bubble, an electrostatic suction method in which ink is charged to use electrostatic suction force, or the like may be used. In the ink jet image forming method according to the present invention, any recording apparatus including a recording head which ejects ink by any one of such methods can be used. Further, as a method of controlling the timing of ejecting ink, a continuous method in which ink is constantly ejected and unnecessary ink is collected before the ink is applied to a printing paper sheet, an on-demand method in which ink is ejected only when the ink is desired to be applied to a printing paper sheet, or the like may be used. In the ink jet image forming method according to the present invention, any recording apparatus which controls the timing of ejecting ink by any one of such methods can be used.

FIG. 1 is a schematic view illustrating an exemplary ink jet recording apparatus having a serial type recording head. A recording head which ejects ink in an ink jet recording system is mounted on a carriage 20. The recording head includes multiple ink ejection orifices 211 to 215. As a method of applying ink while the recording head scans once, a method in which ink of one color is ejected from one nozzle array (ink ejection orifices) or a method in which ink of one color or inks of multiple colors are ejected from multiple nozzle arrays may be used. Ink cartridges 221 to 225 include a recording head, the ink ejection orifices 211 to 215, and an ink tank for supplying ink to these ink cartridges 221 to 225. A density sensor 40 is a reflection density sensor, and detects, in a state of being provided on a side surface of the carriage 20, the density of a test pattern recorded on a printing paper sheet 24. A control signal and the like are transferred via a flexible cable 23 to the recording head.

The printing paper sheet 24 having a coating layer formed thereon passes a transport roller (not shown) and then is picked up by a delivery roller 25, and is conveyed in the direction of the arrow (sub scan direction) while a conveyer motor 26 is driven. The carriage 20 is guided and supported by a guide shaft 27 and a linear encoder 28. The carriage 20 is driven by a carriage motor 30 via a drive belt 29 to reciprocate along the guide shaft 27 in the main scan direction. A heat generating element (electrothermal energy converter) for generating thermal energy for ejecting ink or a piezoelectric element (electropressure converter) is provided in the recording head (liquid path). With the timing of reading of the linear encoder 28, the heat generating element or the piezoelectric element is driven based on a record signal, and an ink droplet is ejected onto the printing paper sheet 24 to be fixed thereto to form an image.

A recovery unit 32 including caps 311 to 315 is provided at a home position of the carriage 20 which is provided outside a recording region. When recording is not performed, the carriage 20 is moved to the home position and the ink ejection orifices 211 to 215 are hermetically sealed with the corresponding caps 311 to 315, respectively. This can prevent clogging caused by adhesion of ink due to evaporation of a liquid component thereof or by adhesion of foreign matter such as dust and the like. Further, the capping function of the caps is used to prevent ejection failure and clogging of an ink ejection orifice which is infrequently used for recording. Specifically, the caps are used for blank ejection for preventing ejection failure of the ink ejection orifices. Further, the caps are used for recovery of ejection of an ink ejection orifice in which ejection failure has occurred, by sucking ink from the ink ejection orifice using a pump (not shown).

An ink receiving portion 33 plays a role in receiving an ink droplet which is preliminarily ejected when the recording head passes thereover immediately before recording operation. Further, by providing a blade or a wiping member (not shown) at a location adjacent to the caps 311 to 315, the ink ejection orifices 211 to 215 can be cleaned. Adding a recovery unit of the recording head and other auxiliary units to the structure of the recording apparatus is preferred, because the recording operation can be stabilized. Specifically, it is preferred to add to the structure of the recording apparatus, for example, a capping unit, a cleaning unit, a pressurizing or suction unit, an electrothermal energy converter, other kinds of a heating element, or an auxiliary heating unit as a combination thereof, for the recording head. Further, it is also effective to provide a preliminary ejection mode for performing ejection other than ejection for recording, in order to stabilize the recording operation. Further, a recording head of a cartridge type in which an ink tank is integrally provided may also be used. Further, there may also be used a replaceable recording head of a chip type which can be electrically connected to a body of the recording apparatus and to which ink can be supplied from the recording apparatus by being mounted to the body of the recording apparatus.

FIG. 2 is a schematic view illustrating an exemplary serial type recording head. FIG. 2 illustrates the recording head including the ink ejection orifices 211 to 215 illustrated in FIG. 1. Note that, in FIG. 2, the scan direction of the recording head (recording scan direction) is the direction of the arrow. The recording head includes the multiple ink ejection orifices 211 to 215 which are arranged in a direction substantially orthogonal to the recording scan direction. The recording head ejects ink droplets at predetermined timing from the respective ejection orifices while the recording head moves and scans in the recording scan direction. This forms an image on the printing paper sheet with a recording resolution based on the arrangement density of the ink ejection orifices (nozzle arrays). Note that, the recording operation of the recording head may be in any one of the recording scan direction and a direction opposite to the recording scan direction.

As the recording apparatus, a full line type recording apparatus including a recording head having a length corresponding to the width of the printing paper sheet may also be used. As the full line type recording head, for example, one having an increased length by arranging serial type recording heads in a staggered manner or in parallel with one another so as to have an intended length may be used. The recording head may also be one recording head in which ink ejection orifices 216 to 220 (nozzle columns) which are originally long are integrally formed as illustrated in FIG. 3.

The recording apparatus which can be used in the ink jet image forming method according to the present invention can form a line image having a recording density of 600 dpi or more and 4,800 dpi or less and a width of adjacent four pixels or more. It is preferred that the recording apparatus have a control mechanism which can, in forming such a line image, set the average ink application amount per unit area in the line image to be 0.3 μL/cm² or more and 1.5 μL/cm² or less.

<Recording Medium>

The recording medium to be used in the ink jet image forming method according to the present invention is a printing paper sheet having a coating layer formed thereon mainly used in offset printing, gravure printing, or the like. The coating layer is a layer of a coating provided on a front surface and/or a rear surface of woodfree paper or medium quality paper, or a layer of a coating formed when the paper is made, for the purpose of enhancing the aesthetic appearance or the smoothness of the surface of the paper.

According to “Census of Manufactures” by Ministry of Economy, Trade, and Industry and “Classification Table of Paper and Paperboard” in “Paper and Paperboard Statistics Yearbook” by Japan Paper Association, a printing paper sheet having a coating layer formed thereon is in the category of coated printing paper and lightly coated paper in “printing and communication paper sheets”. The former has a coating layer formed thereon by applying a coating which is about 15 g to 40 g per 1 m² on a surface (both surfaces) of a paper sheet. The latter has a coating layer formed thereon by applying a coating which is 12 g or less per 1 m² on a surface (both surfaces) of a paper sheet. The coated printing paper is further broken down into art paper, coated paper, light weight coated paper, and other coated printing paper (cast-coated paper, embossed paper, and the like) in accordance with the amount of an applied coating, the method of surface treatment after the coating application, and the like. Further, according to the glossiness of the surface it is also classified into gloss paper, matte paper, dull paper, and the like. The printing paper sheet to be used in the ink jet image forming method according to the present invention may be any one of these printing paper sheets having a coating layer formed thereon.

It is preferred that, when the entire printing paper sheet is measured by X-ray florescence analysis (XRF), the proportion of calcium with respect to the other elements than carbon and oxygen be 5.0 mass % or more. By using such a printing paper sheet, interaction thereof with the above-mentioned ink improves the coagulation rate of the pigment to reduce the image unevenness. Note that, with XRF described above, the amounts of various kinds of elements existing in a paper sheet having a thickness of about 100 μm can be measured with good reproducibility by only fixing a sample (paper) on a sample stage and applying X-rays thereto. XRF cannot detect hydrogen, helium, lithium, and a superheavy element which is uranium or a heavier element from the measuring principle thereof. However, it is almost impossible that helium, lithium, or a superheavy element which is uranium or a heavier element exists in the paper with a proportion which is not negligible. Therefore, the element proportion obtained by analysis of paper with XRF can be said to be substantially the proportion of the element with respect to all elements forming the paper except hydrogen.

The mainstream of printing today is offset printing using an oil-based ink. Therefore, the coating layer has such a structure that a coloring material and liquid component (in particular, a hydrophilic liquid component) incorporated in the ink are difficult to penetrate therein. Therefore, it is preferred to use a printing paper sheet having a coating layer formed thereon, the coating layer having pores with an average diameter of 0.1 μm or less and a pore volume of 0.3 mL/g or less.

In the ink jet image forming method according to the present invention, as the printing paper sheet having a coating layer formed thereon, the following printing paper sheets (trade names) can be used.

Examples of the art paper may include: OK Ultra Aquasatin, OK Kinfuji, SA Kinfuji, and Satin Kinfuji (all of which are manufactured by Oji Holdings Corporation); Hyperpyrenee and Silverdia (both of which are manufactured by Nippon Paper Industries Co., Ltd.); Green Utrillo (manufactured by Daio Paper Corporation); Pearl Coat and New V Matte (both of which are manufactured by MITSUBISHI PAPER MILLS LIMITED); Raicho Super Art (manufactured by Chuetsu Pulp & Paper Co., Ltd.); and Hi-Mckinley (manufactured by Gojo Paper MFG., Co. Ltd.). Examples of the coated paper may include OK Top Coat, OK Top Coat dull, OK Top Coat matte, OK Trinity, and OK Casablanca (all of which are manufactured by Oji Holdings Corporation); Aurora Coat, Silverdia, and Shiraoi matte (all of which are manufactured by Nippon Paper Industries Co., Ltd.); Green Utrillo (manufactured by Daio Paper Corporation); and Pearl Coat and New V Matte (both of which are manufactured by MITSUBISHI PAPER MILLS LIMITED).

Examples of the lightweight coated paper may include: OK Coat L (manufactured by Oji Holdings Corporation); Aurora L, Easter DX, and Pegasus (all of which are manufactured by Nippon Paper Industries Co., Ltd.); Utrillo Coat L (manufactured by Daio Paper Corporation); Pearl Coat L (manufactured by MITSUBISHI PAPER MILLS LIMITED); Super Emine (manufactured by Chuetsu Pulp & Paper Co., Ltd.); and Dream Coat (manufactured by MARUSUMI PAPER CO., LTD.). Examples of the cast coated paper may include: Mirror Coat Platinum and OK Chrome (both of which are manufactured by Oji Holdings Corporation); Esprit Coat (manufactured by Nippon Paper Industries Co., Ltd.); and Picasso Coat (manufactured by Daio Paper Corporation). Further, examples of the lightly coated printing paper sheet may include: OK Ever Light, OK Crystal, and OK Prunus White (all of which are manufactured by Oji Holdings Corporation); and Pyrenee DX and Aurora S (both of which are manufactured by Nippon Paper Industries Co., Ltd.).

### EXAMPLES

Next, the present invention is described more specifically by way of examples and comparative examples. Note that, “part” and “%” in the following description are based on the mass unless otherwise noted. Further, the surface tensions of the inks were measured using a surface tension meter (trade name “CBVP-Z” manufactured by Kyowa Interface Science Co., Ltd.). Further, the viscosities of the inks were measured using a viscometer (trade name “RE-80 Viscometer” manufactured by TOKI SANGYO CO., LTD).

<Production of Hydrophilic Polymer Emulsion A>

Polymerization was performed according to an ordinary method using styrene/n-butyl acrylate/acrylic acid of 3.0/6.0/1.5 (mass ratio), sodium dodecyl sulfate of 0.25 (mass ratio), and potassium persulfate (manufactured by Sigma-Aldrich) as an initiator. After the polymerization, the resultant was neutralized with a potassium hydroxide (KOH) aqueous solution, purified, and concentrated to obtain a hydrophilic polymer emulsion A having a solid content of 10%. The pH of the resultant hydrophilic polymer emulsion A was adjusted to 8.5. The polymer particles contained in the hydrophilic polymer emulsion A had an average particle diameter (D50) of 122 nm. Further, the polymer constituting the polymer particles had an acid value of 101 mgKOH/g and a glass transition temperature (Tg) of −3° C.

<Production of Hydrophilic Polymer Emulsion B>

A hydrophilic polymer emulsion B having a solid content of 10 mass % was obtained in the same manner as in “Production of Hydrophilic Polymer Emulsion A” described above except for using styrene/n-butyl acrylate/acrylic acid of 7.0/2.0/1.5 (mass ratio). The pH of the resultant hydrophilic polymer emulsion B was adjusted to 8.5. The polymer particles contained in the hydrophilic polymer emulsion B had an average particle diameter (D50) of 130 nm. Further, the polymer constituting the polymer particles had an acid value of 100 mgKOH/g and a glass transition temperature (Tg) of 58° C.

<Preparation of Inks (Inks 1 to 18)>

The components constituting inks were mixed according to compositions shown in Tables 2-1 to 2-3 (total: 100 parts), and then stirred for 1 hour. Next, the mixtures were filtered through a filter having a pore diameter of 2.5 μm to prepare the inks. Note that, “Water” in Tables 2-1 to 2-3 refers to ion exchanged water, and “Acetylenol EH” is a trade name of a nonionic surfactant (manufactured by Kawaken Fine Chemicals Co., Ltd.). Further, aqueous dispersions of various anionic self-dispersion pigments shown below were used as “Kind of pigment” in Tables 2-1 to 2-3.

CW-1S: black pigment manufactured by Orient Chemical Industries Co., Ltd. (trade name “BONJET BLACK CW-1S”)

COJ200: black pigment manufactured by Cabot (trade name “CAB-O-JET 200”)

COJ300: black pigment manufactured by Cabot (trade name “CAB-O-JET 300”)

COJ400: black pigment manufactured by Cabot (trade name “CAB-O-JET 400”)

COJ450C: cyan pigment manufactured by Cabot (trade name “CAB-O-JET 450C”)

COJ465M: magenta pigment manufactured by Cabot (trade name “CAB-O-JET 465M”)

TABLE 2-1

| | | Ink 1 | Ink 2 | Ink 3 | Ink 4 | Ink 5 | Ink 6 |
|---|---|---|---|---|---|---|---|
| Pigment | Type | CW-1S | CW-1S | CW-1S | CW-1S | CW-1S | CW-1S |
| | Amount | 1 | 2 | 2 | 3 | 2 | 2 |

| | | | | | | |
|---|---|---|---|---|---|---|
| Polymer Emulsion A | 2 | 2 | 1 | 1 | 2 | 2 |
| (Glass Transition | | | | | | |
| Temperature: −3° C.) | | | | | | |
| Polymer Emulsion B | — | — | — | — | — | — |
| (Glass Transition | | | | | | |
| Temperature: 58° C.) | | | | | | |
| Glycerol | — | — | — | — | — | 20 |
| Trimethylolpropane | 15 | 15 | 15 | 15 | 20 | — |
| 1,2-Hexanediol | 5 | 5 | 5 | 5 | — | — |
| Acetylenol EH | 1 | 1 | 1 | 1 | 1 | 1 |
| Water | Remainder | Remainder | Remainder | Remainder | Remainder | Remainder |
| Viscosity (mpa · s) | 2.4 | 2.6 | 2.3 | 2.4 | 3 | 2.9 |
| Surface tension | 32 | 32 | 32 | 31 | 32 | 28 |
| (mN/m) | | | | | | |

TABLE 2-2

| | | Ink 7 | Ink 8 | Ink 9 | Ink 10 | Ink 11 | Ink 12 |
|---|---|---|---|---|---|---|---|
| Pigment | Type | COJ200 | COJ300 | COJ400 | COJ450C | COJ465M | CW-1S |
| | Amount | 2 | 2 | 2 | 2 | 2 | 2 |

| | | | | | | |
|---|---|---|---|---|---|---|
| Polymer Emulsion A | 2 | 2 | 2 | 2 | 2 | — |
| (Glass Transition | | | | | | |
| Temperature: −3° C.) | | | | | | |
| Polymer Emulsion B | — | — | — | — | — | 2 |
| (Glass Transition | | | | | | |
| Temperature: 58° C.) | | | | | | |
| Glycerol | — | — | — | — | — | — |
| Trimethylolpropane | 15 | 15 | 15 | 15 | 15 | 15 |
| 1,2-Hexanediol | 5 | 5 | 5 | 5 | 5 | 5 |
| Acetylenol EH | 1 | 1 | 1 | 1 | 1 | 1 |
| Water | Remainder | Remainder | Remainder | Remainder | Remainder | Remainder |
| Viscosity (mpa · s) | 2.8 | 2.9 | 2.9 | 2.8 | 2.7 | 2.6 |
| Surface tension | 31 | 33 | 31 | 31 | 31 | 32 |
| (mN/m) | | | | | | |

TABLE 2-3

| | | Ink 13 | Ink 14 | Ink 15 | Ink 16 | Ink 17 | Ink 18 |
|---|---|---|---|---|---|---|---|
| Pigment | Type | COJ200 | COJ300 | COJ400 | CW-1S | COJ200 | CW-1S |
| | Amount | 2 | 2 | 2 | 2 | 2 | 2 |

| | | | | | | |
|---|---|---|---|---|---|---|
| Polymer Emulsion A | — | — | — | — | — | 2 |
| (Glass Transition | | | | | | |
| Temperature: −3° C.) | | | | | | |
| Polymer Emulsion B | 2 | 2 | 2 | — | — | — |
| (Glass Transition | | | | | | |
| Temperature: 58° C.) | | | | | | |
| Glycerol | — | — | — | — | — | — |
| Trimethylolpropane | 15 | 15 | 15 | 15 | 15 | 20 |
| 1,2-Hexanediol | 5 | 5 | 5 | 5 | 5 | |
| Acetylenol EH | 1 | 1 | 1 | 1 | 1 | 0.1 |
| Water | Remainder | Remainder | Remainder | Remainder | Remainder | Remainder |
| Viscosity (mpa · s) | 2.5 | 2.7 | 2.6 | 2.0 | 2.0 | 2.9 |
| Surface tension | 32 | 32 | 31 | 32 | 32 | 40 |
| (mN/m) | | | | | | |

### Image Forming Method A

### Examples 1 to 14 and Comparative Examples 1 to 8

Prepared inks were used to form an image on a printing paper sheet having a coating layer formed thereon (trade name “OK Top Coat” manufactured by Oji Holdings Corporation). Specifically, an ink tank filled with ink was mounted on a black ink head portion of a recording apparatus (printer), and a line image having a width of 8 pixels and a line image having a width of 25 pixels which correspond to 1,200 dpi were printed using a print pattern formed by uniform and random dots. Note that, all the predetermined line images were printed by one passage. Table 3 shows the used inks, the recording apparatus, the average ink application amounts, and the results of evaluation of the images. Further, the types of the used recording apparatus are as follows.
Recording apparatus A: trade name “BJF900” (manufactured by Canon Inc., recording head: six ejection orifice arrays×512 nozzles, amount of ink droplets: 4.0 pL (fixed amount), recording density: 1,200 dpi (transverse direction)×1,200 dpi (machine direction))

Recording apparatus B: trade name “BJF950” (manufactured by Canon Inc., recording head: six ejection orifice arrays×512 nozzles, amount of ink droplet: 2.0 pL (fixed amount), recording density: 2,400 dpi (transverse direction)×1,200 dpi (machine direction))

Recording apparatus C: trade name “W6200” (manufactured by Canon Inc., recording head: six ejection orifice arrays×1,280 nozzles, amount of ink droplet: 8.5 pL (fixed amount), recording density: 600 dpi (transverse direction)×1,200 dpi (machine direction))

<Evaluation Method of Image>

Line Thickening

A digital microscope (trade name “Personal IAS” manufactured by Quality Engineering Associates Inc.) was used to measure the widths of the line images (actually measured values). Then, the difference between the actually measured value and the width of the line image calculated from the recording density (calculated value) was calculated, and the line thickening of the line image having a width of 8 pixels and the line thickening of the line image having a width of 25 pixels were evaluated in accordance with the following evaluation criteria. Note that, the calculated value of the width of the line image having a width of 8 pixels in a recorded product corresponding to a recording density of 1,200 dpi is 169 μm, and the calculated value of the width of the line image having a width of 25 pixels in a recorded product corresponding to a recording density of 1,200 dpi is 529 μm. In the following evaluation criteria, “A” and “B” are acceptable levels, and “C” to “F” are unacceptable levels.

A: (Actually measured value)-(calculated value) was less than 30 μm.

B: (Actually measured value)-(calculated value) was 30 μm or more and less than 60 μm.

C: (Actually measured value)-(calculated value) was 60 μm or more and less than 100 μm.

D: (Actually measured value)-(calculated value) was 100 μm or more and less than 150 μm.

E: (Actually measured value)-(calculated value) was 150 μm or more and less than 200 μm.

F: (Actually measured value)-(calculated value) was 200 μm or more.

Image Unevenness

The printed line images were visually observed using a loupe, and the image unevenness was evaluated in accordance with the following evaluation criteria. Note that, in the following evaluation criteria, “A” and “B” are acceptable levels, and “C” is an unacceptable level.

A: Unevenness was not at all recognized, and a satisfactory line image was formed.

B: Unevenness was slightly recognized, but a line image which presents practically no problem was formed.

C: Unevenness was caused, and a low quality line image was formed.

Fixability

After a lapse of 20 seconds after a solid image was printed, the solid image was rubbed once with a lens-cleaning paper sheet with a weight of 360 g mounted thereon. The extent of fading of the ink in the solid image was visually observed, and the fixability was evaluated in accordance with the following evaluation criteria. Note that, in the following evaluation criteria, “A” and “B” are acceptable levels, and “C” is an unacceptable level.

A: No fading was recognized, and the lens-cleaning paper sheet did not get dirty.

B: Fading was slightly recognized.

C: Fading was clearly recognized.

TABLE 3

| | | | Average Ink | | | | |
|---|---|---|---|---|---|---|---|
| | | | Application | Line | Line | | |
| | Recording | | Amount | Thickening | Thickening | Image | |
| | Apparatus | Ink | (μL/cm²) | (8 pixels) | (25 pixels) | Unevenness | Fixability |
| Example 1 | A | Ink 1 | 0.45 | A | A | A | A |
| Example 2 | A | Ink 2 | 0.45 | A | A | A | A |
| Example 3 | A | Ink 3 | 0.45 | A | A | A | A |
| Example 4 | A | Ink 4 | 0.45 | A | A | A | A |
| Example 5 | A | Ink 1 | 0.90 | A | A | A | A |
| Example 6 | A | Ink 2 | 0.90 | A | A | A | A |
| Example 7 | A | Ink 3 | 0.90 | A | A | A | B |
| Example 8 | A | Ink 4 | 0.90 | A | A | B | B |
| Example 9 | A | Ink 5 | 0.90 | A | A | B | A |
| Example 10 | A | Ink 6 | 0.90 | B | B | B | B |
| Example 11 | A | Ink 7 | 0.90 | A | A | A | A |
| Example 12 | A | Ink 8 | 0.90 | A | A | A | A |
| Example 13 | A | Ink 9 | 0.90 | A | A | A | A |
| Example 14 | B | Ink 2 | 0.90 | A | A | A | A |
| Comparative | A | Ink 12 | 0.90 | E | E | C | C |
| Example 1 | | | | | | | |
| Comparative | A | Ink 13 | 0.90 | D | E | C | C |
| Example 2 | | | | | | | |
| Comparative | A | Ink 14 | 0.90 | F | F | C | C |
| Example 3 | | | | | | | |
| Comparative | A | Ink 15 | 0.90 | D | E | C | C |
| Example 4 | | | | | | | |
| Comparative | A | Ink 16 | 0.90 | F | F | C | C |
| Example 5 | | | | | | | |
| Comparative | A | Ink 17 | 0.90 | F | F | C | C |
| Example 6 | | | | | | | |
| Comparative | A | Ink 18 | 0.90 | A | A | B | C |
| Example 7 | | | | | | | |
| Comparative | C | Ink 2 | 0.90 | B | B | C | B |
| Example 8 | | | | | | | |

As shown in Table 3, when Inks 1 to 9 containing polymer particles formed of a polymer having a glass transition temperature of −3° C. were used, line thickening and image unevenness were suppressed, and it was possible to record line images excellent in fixability (Examples 1 to 14). On the other hand, when Inks 12 to 15 containing polymer particles formed of a polymer having a glass transition temperature of 58° C. and Inks 16 and 17 which did not contain polymer particles were used, neither line thickening nor image unevenness was suppressed. Further, the fixability was conspicuously reduced (Comparative Examples 1 to 6). Note that, the fixability of a line image recorded using an ink having a high surface tension was conspicuously reduced (Comparative Example 7). Further, image unevenness was caused with regard to a line image recorded using a recording apparatus in which the amount of an ink droplet ejected was large (Comparative Example 8).

### Image Forming Method B

### Examples 15 to 17 and Comparative Example 9

Prepared inks were used to form an image on a printing paper sheet having a coating layer formed thereon (trade name “OK Top Coat” manufactured by Oji Holdings Corporation). Specifically, two ink tanks filled with ink were mounted side by side in adjacent ink head portions of the above-mentioned recording apparatus (printer). Note that, when different types of inks were used, the respective inks were filled in separate ink tanks. The same amount of inks were ejected from the two ink tanks so that the average ink application amount was as shown in Table 4, and a line image having a width of 8 pixels and a line image having a width of 25 pixels which correspond to 1,200 dpi were printed using the print pattern formed by uniformly and random dots. Note that, all the predetermined line images were printed by one passage. Further, the “average ink application amount” shown in Table 4 is the total amount of the applied inks. Table 4 shows the used inks, the recording apparatus, the average ink application amounts, and the results of evaluation of the images.

TABLE 4

| | | | Average Ink | | | | |
|---|---|---|---|---|---|---|---|
| | | | Application | Line | Line | | |
| | Recording | | Amount | Thickening | Thickening | Image | |
| | Apparatus | Ink | (μL/cm²) | (8 pixels) | (25 pixels) | Unevenness | Fixability |
| Example 15 | A | Ink 2/ | 0.90 | A | A | A | A |
| | | Ink 9 | | | | | |
| Example 16 | A | Ink 10/ | 0.90 | A | A | A | A |
| | | Ink 11 | | | | | |
| Example 17 | A | Ink 2 | 1.35 | B | B | A | B |
| Comparative | A | Ink 2 | 1.80 | C | C | C | B |
| Example 9 | | | | | | | |

As shown in Table 4, also with regard to line images recorded by ejecting inks from the two ink tanks, line thickening and image unevenness were suppressed, and it was possible to record line images excellent in fixability (Examples 15 to 17). On the other hand, when recording was performed with the average ink application amount being increased, it was apparent that neither line thickening nor image unevenness was suppressed and the fixability was conspicuously reduced (Comparative Example 9).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-042805, filed, Feb. 29, 2012, which is hereby incorporated by reference herein in its entirety.

What is claimed is:

1. An ink jet image forming method for forming an image comprising applying ink to a printing paper sheet using a recording head of an ink jet system,
wherein the ink contains a self-dispersion pigment, a polymer particle having a glass transition temperature of 25° C. or lower, and water and has a surface tension of 34 mN/m or less, and
wherein when recording a line image having a recording density of 600 dpi or more and 4,800 dpi or less and a width of adjacent four pixels or more by conducting one scanning of the recording head, an amount of an ink droplet applied from the recording head is 0.6 pL or more and 6.0 pL or less, and an average ink application amount per unit area in the line image is 0.3 μL/cm² or more and 1.5 μL/cm² or less.

2. An ink jet image forming method according to claim 1, wherein the polymer particle has the glass transition temperature of 15° C. or lower, and is formed of a hydrophilic acrylic polymer.

3. An ink jet image forming method according to claim 1, wherein the ink further contains a water-soluble compound having a hydrophilicity-hydrophobicity coefficient of 0.26 or more, the hydrophilicity-hydrophobicity coefficient being defined by the following equation (A),
(hydrophilicity-hydrophobicity coefficient)−((water activity value of 20-mass % aqueous solution)−(molar fraction of 20-mass % aqueous solution))/(1−(molar fraction of water in 20-mass % aqueous solution)). Eq. (A):

4. An ink jet image forming method according to claim 1, wherein the ink has a viscosity of 6 mPa·s or less.
